(19) United States
(12) Patent Application Publication
(10) Pub. No.: US 2025/0308488 A1
(43) Pub. Date: Oct. 2, 2025

(54) Bridge for a Stringed Instrument

(71) Applicant: Tuffset Limited, East Sussex (GB)

(72) Inventor: Daniel Katz, Gloucestershire (GB)

(21) Appl. No.: 18/865,000

(22) PCT Filed: May 21, 2023
(86) PCT No.: PCT/IB2023/055223

§ 371 Date: Nov. 12, 2024

(30) Foreign Application Priority Data
May 20, 2022 (GB) 2207426.4

(51) Int. Cl. G10D 3/04; G10D 1/08

(52) U.S. Cl. CPC G10D 3/04; G10D 1/08

(57) ABSTRACT

A bridge (101) for a stringed instrument (100) has a bridge chassis (200) and at least one saddle (202). The saddle (202) allows adjustment of string height and intonation. In order to achieve this, a height adjustment fixing (414) and an intonation locking fixing (404) are manipulable to urge the saddle element (410′) against an interfacing wedge (412) in respective different directions to lock the saddle element (410′) in a desired position against the interfacing wedge (412).

### TECHNICAL FIELD

The present invention is concerned with improvements in or relating to a bridge or bridge assembly for a stringed instrument. The bridge of the invention may allow string height (commonly known as “action”) and precise string speaking length (commonly known as “intonation”) to be set and locked into position for one or several strings per saddle. It is of particular benefit to those stringed instruments whose break angle of the string over the saddle is shallow, or whose string tension is lower than anticipated when the instrument was designed.

### BACKGROUND

Existing bridge assemblies for stringed instruments very often require a certain minimum level of string tension (whether direct or vectorised) for their adjustable features to hold position over time; or to ensure a sufficient transfer of energy from the string to the instrument to be desirable. This is not always realised, or possible, leading to inadequate or unreliable support for the strings at the bridge.

### SUMMARY OF THE INVENTION

It is an object of the present invention to overcome or at least mitigate the drawbacks and disadvantages of available stringed instrument bridges by allowing fixings on two relevant axes of adjustment to be affixed to the bridge chassis against each other; and independently of string tension (or associated pressures that are a product of string tension and geometry).

Aspects of the invention are set out in the claims.

According to one aspect, there is provided a bridge for a stringed instrument, the bridge comprising:
a bridge chassis;
and at least one saddle for supporting a string of the stringed instrument, wherein the saddle comprises:
a saddle element for receiving the string;
a height adjustment fixing;
an intonation locking fixing; and
an interfacing wedge arranged to abut the saddle element such that movement of the saddle element over an inclined surface of the interfacing wedge results in a change in the height of the saddle element with respect to the bridge chassis,
wherein the height adjustment fixing and the intonation locking fixing are manipulable to urge the saddle element against the inclined surface of the interfacing wedge in respective different directions and thereby to lock the saddle element in a desired position against the inclined surface of the interfacing wedge.

Optionally, the inclined surface has an angle of incline between around 30 and 60 degrees relative to a direction along the length of the string received by saddle element.

Optionally, the intonation locking fixing is arrangeable in a first position to urge the saddle element towards the bridge chassis.

Optionally, the intonation locking fixing is arrangeable in a second position to be slidable in an intonation slot in the bridge chassis to adjust the position of the saddle element in an intonation direction.

Optionally, the height adjustment fixing is arrangable in a first position to set a position of the saddle element on the inclined surface of the interfacing wedge.

Optionally, the intonation locking fixing and height adjustment fixing extend substantially perpendicularly to one another.

Optionally, the saddle element has a slot for accommodating a string of the stringed instrument along the length of the slot.

Preferred embodiments of the invention will now be described with reference to the accompanying drawings, by way of example only.

### BRIEF DESCRIPTION OF THE DRAWINGS

FIG. 1 is a side view of a guitar according to a preferred embodiment.

FIG. 2 is a schematic view of a part of a bridge of the guitar, illustrating a principle of operation of a saddle of the bridge.

FIGS. 3a and 3b are perspective views of the bridge of the guitar, with FIG. 3a being a view towards the neck of the guitar and FIG. 3b being a view away from the neck of the guitar.

FIG. 4a is an exploded perspective view of the bridge.

FIG. 4b is an exploded perspective view of a height adjustable saddle of the bridge.

FIGS. 5a and 5b are cross-sectional views a bridge post assembly of the bridge, with FIG. 5a showing the bridge post assembly prior to insertion of a locking follower and FIG. 5b showing the bridge post assembly after the locking follower has been inserted.

FIG. 6 is a partial perspective view of a bridge chassis of the bridge.

FIG. 7a is a perspective view from below of a saddle element of a fixed height saddle of the bridge.

FIG. 7b is a perspective view from below of an interfacing wedge of an adjustable height saddle of the bridge.

FIGS. 8a and 8b are perspective views from above of the interfacing.

FIGS. 9 is a perspective view of a saddle element and an interfacing wedge of one of the height adjustable saddles of the bridge, shown upside down in comparison to their normal orientation relative to the bridge.

FIGS. 10a and 10b are perspective views of one of the height adjustable saddles of the bridge, illustrating planes of cross section used for subsequent drawings.

FIGS. 11a to 11e are schematic cross-sectional views of one of the height adjustable saddles of the bridge, illustrating a method of raising the action height of a string of the guitar.

FIGS. 12a to 12e are schematic cross-sectional views of one of the height adjustable saddles of the bridge, illustrating a method of lowering the action height of a string of the guitar.

FIGS. 13a to 13d are schematic cross-sectional views of one of the height adjustable saddles of the bridge, illustrating a method of adjusting the intonation of a string of the guitar.

### DESCRIPTION OF THE PREFERRED EMBODIMENTS

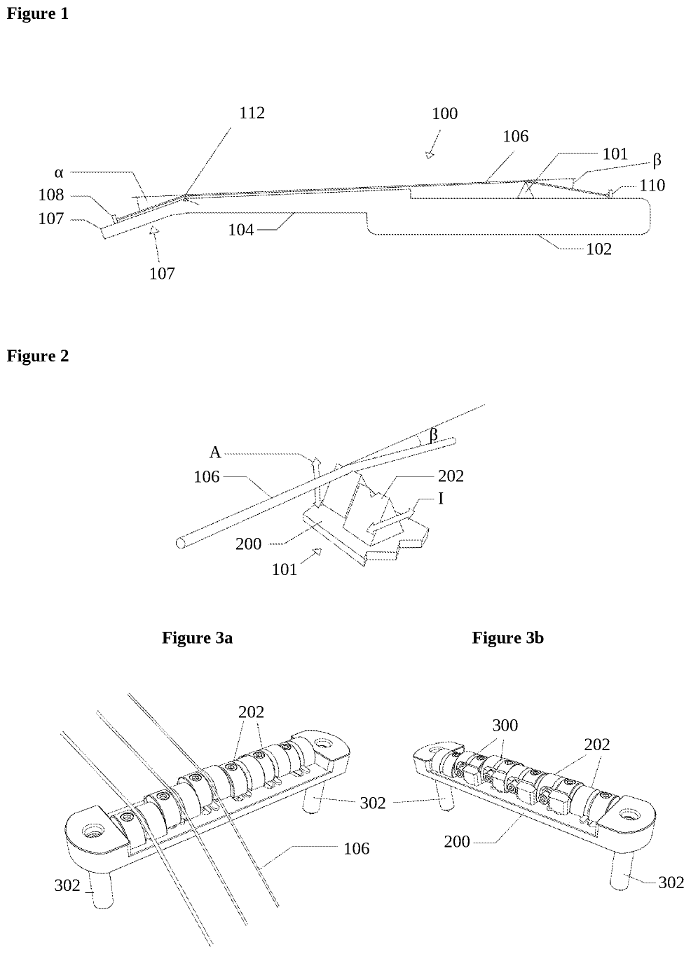

Referring to FIG. 1, a guitar 100 according to a preferred embodiment is shown. The guitar 100 is an electric guitar. However, it should be understood that, whilst the preferred embodiment is described with reference to a guitar and specifically an electric guitar, the invention is applicable to a wide range of stringed instruments. Indeed, any stringed instrument that has a bridge or fulcrum on which the strings are supported may potentially benefit from the invention.

The guitar 100 of the preferred embodiment has a body 102 and a neck 104. The body 102 functions to amplify the sound produced by the guitar 100. In the illustrated embodiment this is achieved by the body 102 housing suitable electronics for detecting vibration of the strings 106 as electrical signals, and coupling these electrical signals to appropriate electrical or electronic amplification equipment (not shown). In other embodiments, such as an acoustic guitar, the amplification is achieved acoustically, e.g. using resonance.

The neck 104 serves as an interface that allows the user to interact with strings 106 of the guitar 100 to cause the guitar 100 to produce different musical notes when the strings 106 vibrate, e.g. by allowing the user to subdivide the strings 106 by pressing them against the neck 104. The body 102 and neck 104 are rigidly attached to one another, and the strings 106 are held in tension between the body 102 and neck 104. More specifically, each string 106 is anchored at each of its ends, one end being held on the body 102 and one end being held on the neck 104.

At one end of the strings 106 at least, a tuning arrangement is provided, typically as part of the anchoring arrangement, that allows the tension of the strings 106 to be varied. Varying the tension of a string 106 causes the string 106 to produce a different note when vibrating in its natural or lowest harmonic, e.g. without being subdivided by the user against the neck 104, e.g. as the user plays the guitar 100. The notes produced at other harmonics are also affected by the tension of the string 106, although this affects playing differently for stringed instruments that have a fret board on their neck 104 to define the positions at which a string 106 is typically subdivided by the user, such as the illustrated guitar 100, as opposed to stringed instruments that have smooth necks that allow the user to subdivide the strings using solely finger location across a continuum of positions.

In the illustrated embodiment, the tuning arrangement is provided on the neck 104 of the guitar 100. The tuning arrangement comprises a headstock 107 at an end of the neck 104 distal from the body 102. The headstock 107 houses tuners 108, typically one for each string 106. The tuners 108 are each in the form of a drum on which an end of a string 106 is wound, which drum may be turned by a peg to vary the tension of the string 106. The drum and peg arrangement typically rotates with high friction so that the tension of the string 106 is maintained without an external force being applied to the peg.

At the other ends of the strings 106, located on the body 102, the anchoring arrangement is in the form of a tailpiece 110. In the illustrated embodiment, the tailpiece 110 is rigidly attached to the body 102. This is sometimes referred to as the guitar 100 having a “hard tail”. In other embodiments, the tailpiece 110 may be part of a vibrato system, sometimes called a “tremolo”, which may allow the tension, length and sounding pitch of the strings 106 to be modulated by the user as they play the guitar 100.

Along the length of the strings 106, between the two ends anchored by the tuning arrangement and the tailpiece 110, there are two fulcrums that define a “speaking length” or “scale length” of the strings 106, as well as their lateral spacing, e.g. the spacing between the strings 106. A first of these fulcrums is on the neck 104 of the guitar 100 and is commonly referred to as a nut 112. A bridge 101 mounted on the body 102 of the guitar 100 provides the second fulcrum.

The headstock 107 is below the nut 112 and the tailpiece 110 is below the bridge 101, in the sense of the direction from which the user interacts with the guitar 100. In other words, the nut 112 and bridge 101 lift the strings 106 away from the neck 104 and body 102 of the guitar 100 such that the strings 106 are free to vibrate along their length between the nut 112 and bridge 101. Angles by which the strings 106 are deflected (downwards) from a direction defined by their length between the nut 112 and bridge 101, as they pass over the nut 112 towards the headstock 107 at one end and over the bridge 101 towards the tailpiece 110 at the other end, are known as break angles. Referring FIG. 1, in the illustrated embodiment the string break angle a at the nut 112 is greater than the string break angle B at the bridge 101, but this is not always the case.

Referring to FIG. 2, the bridge 101 functions to allow the precise location of the fulcrum it provides for each string 106, that is the “second” fulcrum or the fulcrum that is towards the ends of the strings 106 at the tailpiece 110, to be adjusted. In general, the bridge 101 comprises a bridge chassis 200 on which one or more saddles 202 are provided. In the illustrated embodiment, there is one saddle 202 per string 106, that is each string 106 has its own saddle 202. However, in other embodiments multiple strings 106 may be supported by a single saddle 202. In such embodiments, the fulcrums of the strings 106 supported by an individual saddle 202 are generally adjusted together as the saddle 202 moves, although twisting and rocking type translations of such saddles 202 may be used to allow some discrete, if still somewhat coupled, adjustment of the individual fulcrums of the respective strings 106.

The saddles 202 may be adjustable in several directions relative to the bridge chassis 200. In the illustrated embodiment, the saddles 202 are each generally adjustable within a bounded plane, parallel to the direction of the shortest distance between the string 106 and the body 102 or neck 104 of the guitar 100 and to the length of the string 106 it supports, between the two fulcrums. In more detail, one important direction of adjustment is towards and away from the bridge chassis 200 (and body 102 and neck 104 of the guitar 100 in use), as illustrated by arrow A in FIG. 2. This affects the height of the strings 106, e.g. the distance of the strings 106 from (or above) the body 102 and neck 104. This is often referred to as the “action” of the strings 106. Another important direction is along the length of the strings 106, e.g. generally towards or away from the tailpiece 110 (and nut 112), as illustrated by arrow I in FIG. 2. This sets the precise lengths of the strings 106 between the two fulcrums, which is often referred to as the “speaking length” of the strings 106 or “intonation”.

Bridge arrangements exist in the prior art that allow adjustment of the action and intonation of guitar strings. However, these arrangements typically rely on downward pressure being applied to the bridge arrangement by the strings to keep the saddle or saddles in position. Some guitar designs, including (but not limited to) those which use a rocking bridge combined with a vibrato tailpiece, lack sufficient downward and forward pressure to hold the user's adjustments in place over time (especially when used with modern low-tension, smaller gauge strings). These and other stringed instruments can benefit (for reasons both practical and tonal) from a bridge design whose adjustments are kept locked in position in a manner which is independent of string tension.

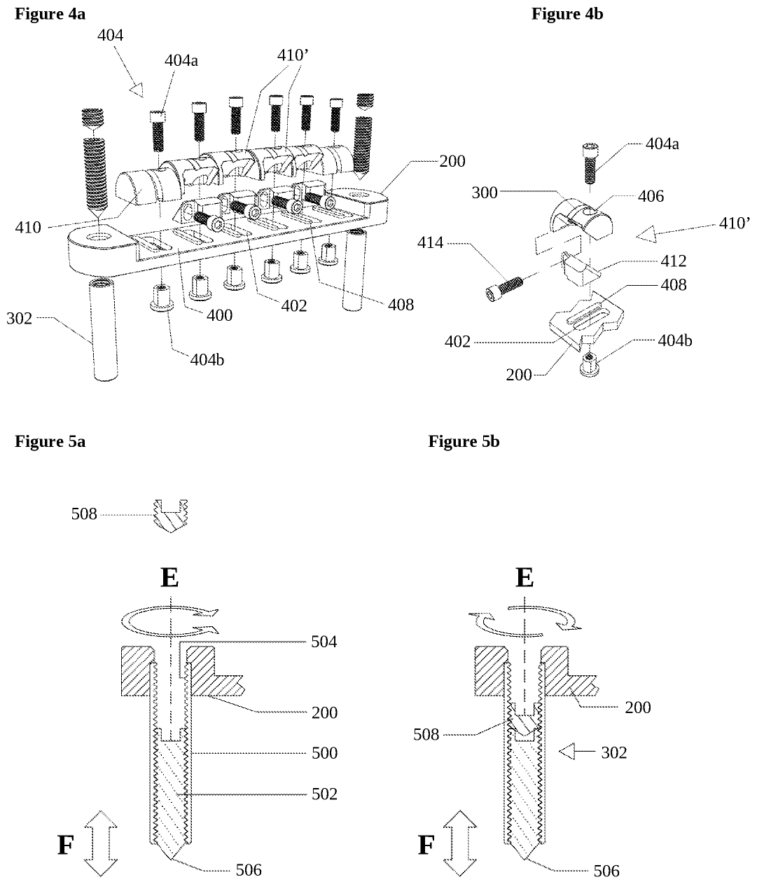

Referring to FIGS. 3a, 3b, 4a and 4b, it can be seen that the bridge 101 of the preferred embodiment comprises saddles 202 for each string 106, e.g. there is one saddle 202 per string 106. Specifically, there are six saddles 202 and six strings 106 in the illustrated embodiment. The bridge chassis 200 supports the saddles 202 and has a bridge post 302 provided at each end. The saddles 202 are arranged in a row. The row extends across the bridge 101, e.g. in a direction transverse and typically perpendicular to the length of the strings 106 in use, or in a direction from one of the bridge posts 302 to the other.

Referring to FIGS. 5a and 5b, the bridge posts 302 each comprise an outer post 500 and an inner post 502. In this embodiment, the outer post 500 is a hollow cylinder and is rigidly attached to the bridge chassis 200. An inner surface 504 of the hollow cylinder of the outer post 500 is provided with a screw thread, along the whole length of the hollow cylinder. The inner post 504 is a cylinder arranged to fit within hollow cylinder of the outer post 500. The inner post 502 also has a screw thread, this time provided on an outer surface of the cylinder of the inner post 502, similarly along the whole length of the cylinder, such that the inner post 502 can be screwed into and through the outer post 500. The inner post 502 effectively has the form of a grub screw or set screw. In other words, the inner post 502 can be screwed all the way into and through the outer post 500.

As can be seen in FIGS. 5a and 5b, the inner post 502 has a narrow or pointed tip 506, which in this embodiment is conical. The inner post 502 is oriented inside the outer post 500 such that the tip 506 is directed downwards, or towards the body 102 of the guitar 100 in use. Rotating the inner post 502, e.g. in the directions of double ended arrow E in FIGS. 5a and 5b, advances and withdraws the inner post 502 within the outer post 500, in the direction of double ended arrow F in FIGS. 5a and 5b. Typically an hexagonal tool or such like may be used to rotate the inner post 502 in this way.

In use, the bridge posts 302 are inserted into the body 102 of the guitar 100. More specifically, the body 102 of the guitar 100 typically houses thimbles (not shown) configured to receive the bridge posts 302, and in some embodiments to provide for the bridge 101 to be rocked or tilted by a tremolo arrangement or such like. The inner posts 502 are typically advanced sufficiently that the tips 506 protrude from the outer posts 500, as shown in FIGS. 5a and 5b, and contact a bottom surface of the thimbles. This allows the overall height of the bridge 101 in relation to the body 102 of the guitar 100 to be set by small further rotations of the inner posts 502 within the outer posts 500. Once the height of the bridge 101 is set, locking followers 508 are inserted into the outer posts 500 to secure the inner posts 502 in position. The locking followers 508 each comprise cylinders with a thread on an outer surface, along the whole length of the cylinder, such that the locking follower 508 can be inserted into the outer post 500 and advanced (or withdrawn) within the outer post 500 similarly to the inner post 502. Once the locking follower 508 abuts the inner post 502, it is difficult for the inner post 502 to rotate within the outer post 500, the inner post 502 is effectively locked in position in the outer post 500 and the height of the bridge 101 in relation to the thimbles is fixed.

Referring back to FIGS. 3a, 3b, 4a and 4b, the saddles 202 each have a groove 300 on a surface facing away from the body 102 of the guitar 100 in use. The grooves 300 extend in a direction generally parallel to the length of the strings 106 in use. The grooves 300 have a width similar to the diameter of the string 106 that the saddle 202 in which they are provided is intended to support. This width may be the same for each saddle 202 or groove 300, or the grooves 300 of different saddles 202 may have different widths, e.g. to support strings of different diameters. In any event, the grooves 300 have a width and depth that encourages the strings 106 to rest in the grooves 300. Spacing between the grooves 300 of the different saddles 202 defines the spacing between the strings 106 in use.

Referring to FIG. 4a, it can be seen that the bridge chassis 200 provides the bridge 101 with structural integrity, in that it is a rigid element extending between the two bridge posts 302. The rigidity of the bridge chassis 200 serves to resist force exerted on the bridge 101 by the strings 106 towards the body 102 of the guitar 100 as a result of their tension and the break angle β of the strings 106 over the bridge 101.

The bridge chassis 200 supports the saddles 202 on a surface 400 of the bridge chassis 200 that faces away from the body 102 of the guitar 100 in use. In this embodiment, the surface 400 is flat. However, it is possible that the surface 400 is sloped or curved. It is also possible that the surface 400 comprises multiple discrete or distinct faces, e.g. in the form of steps along the direction of the row of saddles 202, with the saddles 202 each resting on different faces or steps of the surface 400.

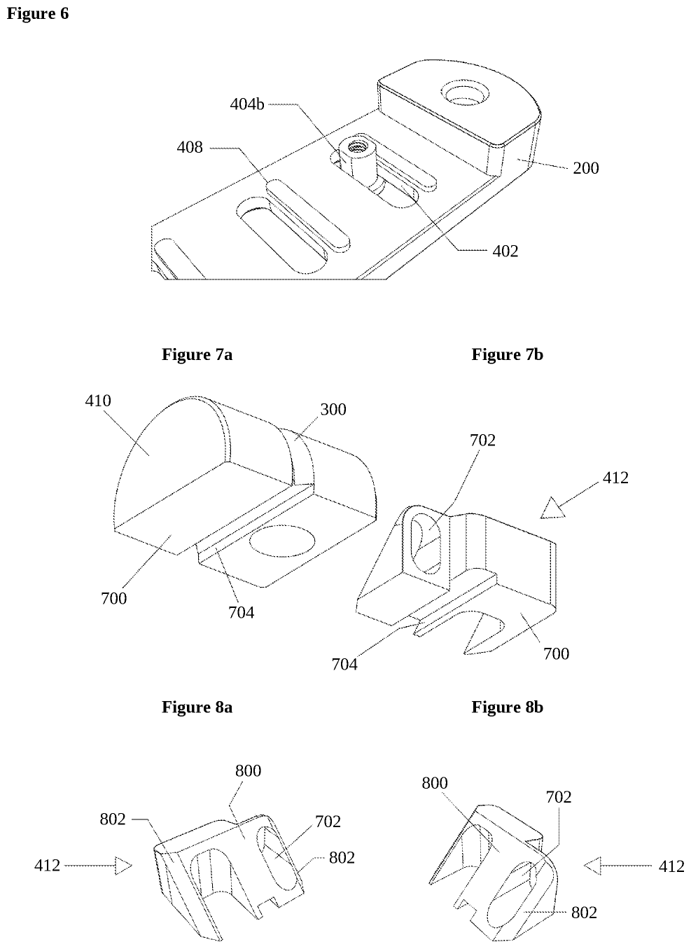

As can be seen most clearly in FIG. 6, the bridge chassis 200 has intonation slots 402 for mounting the saddles 202. The intonation slots 402 extend completely through the bridge chassis 200, that is they are through holes. Their length extends in a direction substantially parallel to the length of the grooves 300 of the saddles 202. In the illustrated embodiment, there is one intonation slot 402 per saddle 202, e.g. each saddle 202 has its own intonation slot 402 in the bridge chassis 200 or, in the illustrated embodiment, there are six intonation slots 402.

The intonation slots 402 each receive an intonation locking fixing 404. The intonation locking fixing 404 is operable to secure the saddle 202 to the bridge chassis 200. It achieves this by urging the saddle 202 against the surface 400 of the bridge chassis 200 on which the saddle 202 is mounted. A width of the intonation locking fixing 404 is similar to a width of the intonation slot 402. This means that with the saddle 202 secured even loosely on the bridge chassis 200 by the intonation locking fixing 404, side walls of the intonation locking fixing 404 cooperate with the intonation slot 402 to resist the saddle 202 moving from side to side (in the sense of the length of the intonation slot 402). On the other hand, the saddle 202 is relatively free to move along the length of the intonation slot 402 unless the intonation locking fixing 404 secures the saddle 202 tightly against the surface 400 of the bridge chassis 200, such that friction between the saddle 202 and the surface 400 resists the saddle 202 moving along the length of the intonation slot 402.

In the illustrated embodiment, the intonation locking fixing 404 comprises a threaded bolt 404a and a cooperating captive nut 404b. The captive nut 404b has flattened side surfaces that cooperate with the intonation slot 402 to prevent the captive nut 404b from moving side to side as mentioned above and also to prevent the captive nut 404b from rotating within the intonation slot 402, thereby allowing rotation of the threaded bolt 404a within the captive nut 404b without the user needing to separately grip the captive nut 404b. Rotation of the threaded bolt 404a within the captive nut 404b adjusts the length of the intonation locking fixing 404. As can be seen more clearly in FIG. 4b, the intonation locking fixing 404 is located in a hole 406 in the saddle 202, such that shortening its length causes the saddle 202 to be urged against the surface 400 as described above. It will be appreciated that the intonation locking fixing 404 can be implemented in other ways in other embodiments, such as using a clamp or ratchet type arrangement, or even just with a similar bolt and nut arrangement in which the nut is not captive.

As can be seen most clearly in FIG. 4a, in this embodiment the bridge 101 has saddles 202 that differ from one another. More specifically, the two outermost saddles 202 are not individually height adjustable. Their height from the body 102 of the guitar 100 can be adjusted together with the bridge 101 as a whole, but their height in relation to the surface 400 of the bridge chassis 200 on which they are mounted is fixed, at least once secured in place by the intonation locking fixing 404. This fixed height is caused by individual saddle elements 410 of the two outermost saddles 202 having substantially flat surfaces 700 (see FIG. 7a) for abutting the surface 400 of the bridge chassis 200 on which they are mounted.

The intonation locking fixing 404 secures the saddle elements 410 of the fixed height saddles 202 by urging the flat surface 700 of the saddle element 410 against the surface 400 of the bridge chassis 200.

The other saddles 202 of the bridge 101 are height adjustable, that is their height from the surface 400 of the bridge chassis 200 on which they are mounted is individually adjustable. In more detail, these saddles 202 comprise both a modified saddle element 410′ and an interfacing wedge 412, as shown in more detail in FIG. 4b. They also have a height adjustment fixing 414.

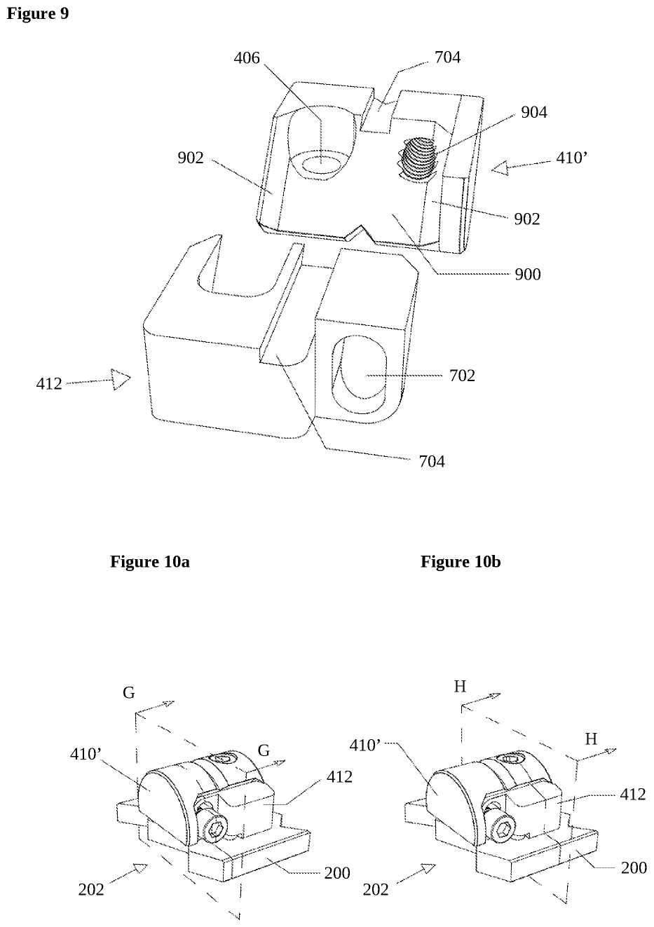

The interfacing wedge 412 is illustrated most clearly in FIGS. 7b, 8a, 8b and 9. As can be seen, the interfacing wedge 412 is generally wedge shaped. Most significantly it provides a ramp on which the saddle element 410′ of the height adjustable saddle 202 rests. In more detail, the flat surface 700 of the saddle 202 that abuts the surface 400 of the bridge chassis 200 when the saddle 202 rests on the bridge chassis 200 is provided on the interfacing wedge 412 rather than the saddle element 410′. This can be seen most clearly in FIG. 7b. The interfacing wedge 412 also has an inclined surface 800 facing in a direction generally, but not directly, opposite to the direction in which the flat surface 700, e.g. away from the body 102 of the guitar 100 in use. The saddle element 410′ may rest on the inclined surface 800 of the interfacing wedge 412 in use. The saddle element 410′ has a corresponding inclined surface 900 that abuts the inclined surface 800 of the interfacing wedge 412 when the saddle element 410′ rests on the interfacing wedge 412. In the illustrated embodiment, the inclined surface 800 of the interfacing wedge 412 has an angle of incline of about 45 degrees relative to a direction along the length of the string 106 received by saddle element 410′, e.g. the plane of the flat surface 700 of the saddle 202 or the surface 400 of the bridge chassis 200 on which the saddle 202 rests. In other embodiments the angle of incline may be between around 30 degrees and 60 degrees, in order facilitate sufficient height adjustment within a reasonably compact bridge 101.

In the illustrated embodiment, the inclined surface 800 of the interfacing wedge 412 and the inclined surface 900 of the saddle element 410′ of the height adjustable saddle 202 are arranged to fit together so as to be slidable over one another along the incline but not from side to side, e.g. transverse to the direction of the incline. This is achieved by the inclined surfaces 800, 900 each being contoured. In more detail the inclined surfaces have contours extending parallel to the incline, such that the shapes of the inclined surfaces 800, 900 generally correspond with one another, fit together or interlock transverse to the incline. In yet further detail, in the illustrated embodiment, the inclined surface 800 of the interfacing wedge 412 is flat with chamfered edges 802 parallel to the incline. The inclined surface 900 of the saddle element 410′ of the adjustable height saddle 202 is flat with raised edges 902 parallel to the incline. The chamfered edges 802 of the interfacing wedge 412 correspond with the raised edges 902 of the saddle element 410′ such that the chamfered edges 802 and raised edges 902 contact one another when the saddle element 410′ rests on the interfacing wedge 412. Indeed, in this embodiment, the chamfered edges 802 and the raised edges 902 contact one another such that the remainder of the inclined surface 800 of the interfacing wedge 412 and the inclined surface 900 of the saddle element 800 do not come together.

Referring back to FIGS. 4a and 4b, the height adjustment fixing 414 is arranged to secure the saddle element 410′ of the height adjustable saddle 202 against the interfacing wedge 412. It is oriented in a different direction to the intonation locking fixing 404. More specifically, the height adjustment fixing 414 is oriented generally transverse, and in the illustrated embodiment perpendicular to, the intonation locking fixing 404, or generally parallel to the length of the strings 106 between the fulcrums. It passes through a slot 702 in the interfacing wedge 412 to a hole 904 in the saddle element 410′. In this embodiment, the height adjustment fixing 414 is in the form of a bolt, the hole 904 has an internal thread for cooperating with the bolt, and a head of the bolt cooperates with the slot 702.

The length of the height adjustment fixing 414 is adjustable. In more detail, in the illustrated embodiment, as the height adjustment fixing 414 is inserted further inside the hole 904, a distance between the head of the bolt in the slot 702 and the hole 904 is reduced. This has the result that the saddle element 410′ is urged to move higher on the inclined surface 800 of the interfacing wedge 412 (and the head of the bolt moves higher in the slot 702), that is the saddle element 410′ moves to a location further from the flat surface 700 of the saddle 202 (or of the interfacing wedge 412 of the saddle 202). Expressed differently, reducing the length of the height adjustment fixing 414 urges the saddle element 410′ of the height adjustable saddle 202 to slide up the inclined surface 800 of the interfacing wedge 412. In order to accommodate this motion, the intonation locking fixing 404 should be in a configuration where it has adequate length (e.g. between the head of the threaded bolt 404a and the captive nut 404b). Movement of the saddle element 410′ may also be against (downward) force exerted on it by the tension of the string 106 it supports, bearing in mind the break angle β.

The bridge 101 also has a saddle alignment arrangement. In the illustrated embodiment, the saddle alignment arrangement comprises a saddle alignment rail 408. More specifically, a saddle rail 408 is provided for each of the saddles 202, that is there are six alignment rails 408. In other embodiments fewer alignment rails 408 or even just one alignment rail 408 may be provided, and alignment of some of the saddles 202 may rely on their interaction with the other saddles 202. The alignment rails 408 are provided on the surface 400 of the bridge chassis 200. The flat surface 700 of the saddles 202 has a corresponding alignment slot 704. The alignment slots 704 and saddle rails 408 mate with one another to ensure that the saddles 202 remain aligned in their respective positions on the surface 400 of the bridge chassis 200. This has the advantage of preventing adjacent saddles 202 interfering with one another, or in some embodiments coming into contact with each other at all, to improve the ease of adjusting them.

In use, the heights of the outermost saddles 202 are generally set first, as they lack individual string-height adjustment. This is achieved by setting the height of the bridge 101 using the bridge posts 302. The precise length of the strings 106 supported by the outermost saddles 202, from the nut 112 to the saddles 202 may then be set by sliding the saddle elements 410 in the intonation slots 402, then securing the saddles 202 in position using the intonation fixing 404.

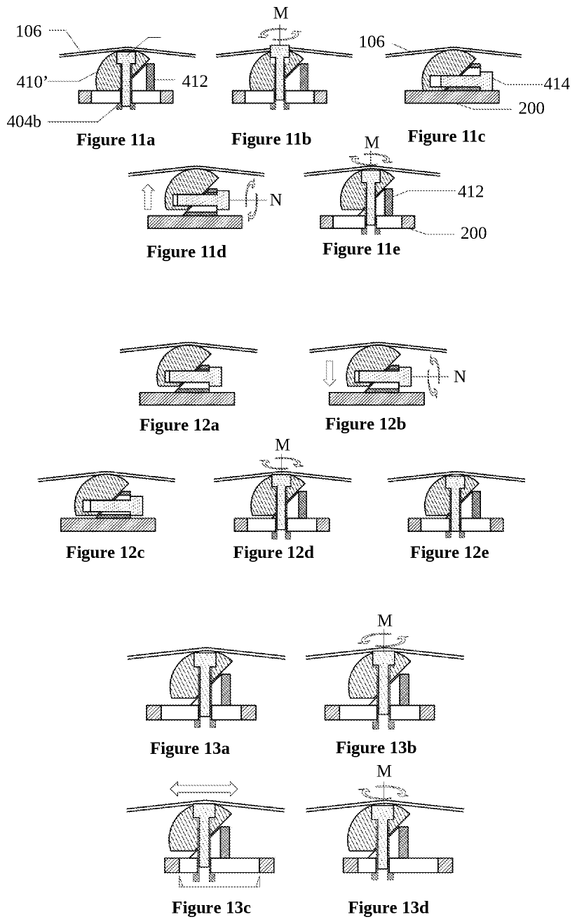

The individual positions of the height adjustable saddles 202 may then be set. This is explained below with referenced to FIGS. 10a to 13d, which are each cross-sectional views of one of the height adjustable saddles 202 and the bridge chassis 200 in different positions during the adjustment process. In more detail, the positions of the saddle element 410′ of the height adjustable saddle 202 and the interfacing wedge 412 in conjunction with the intonation locking fixing 404 are shown using cross-sectional views at the plane and in the direction indicated by arrows G in FIG. 10a. These views are those shown in FIGS. 11a, 11b, 11e, 12d, 12e and 13a to 13d. The positions of the saddle element 410′ of the height adjustable saddle 202 and the interfacing wedge 412 in conjunction with the height adjustment fixing 414 are shown using cross-sectional views at the plane and in the direction indicated by arrows H in FIG. 10b. These views are those shown in FIGS. 11c, 11d, 12a, 12b and 12c.

Referring to FIGS. 11a to 11e, it is first explained how the height of the height adjustable saddle 202 above the bridge chassis 200 is increased. In order to achieve this, the length of the intonation locking fixing 404 is first increased, e.g. the threaded bolt 404a is rotated counter clockwise relative to the captive nut 404b, as illustrated by arrows M in FIG. 11b. This increase in the length of the intonation locking fixing 404 creates clearance between intonation locking fixing 404 and the saddle element 410′, or more specifically between the head of the threaded bolt 404a of the intonation locking fixing 404 and the hole 406 in the saddle element 410′ through which the threaded bolt 404a is inserted. This clearance allows the saddle element 410′ to move upwards or away from the bridge chassis 200, although it is not actually urged to do this, it is only free to do so.

Referring to FIG. 11c, the next step is to shorten the length of the height adjustment fixing 414. In the illustrated embodiment, this is achieved by rotating the height adjustment fixing 414 clockwise relative to the hole 904 of the saddle element 410′ in which the height adjustment fixing 414 is secured, as illustrated by arrows N in FIG. 11d. This shortening of the length of the height adjustment fixing 414 has the effect of urging the saddle element 410′ to slide up the inclined surface 800 of the interfacing wedge 412, as described above. The change in height is illustrated by the different positions of the saddle element 410′ in FIGS. 11c and 11d.

As a final step, the length of the intonation locking fixing 404 may be reduced, e.g. the threaded bolt 404a is rotated clockwise relative to the captive nut 404b, as illustrated by arrows M in FIG. 11e. This reduction in the length of the intonation locking fixing 404 urges the saddle element 410′ towards the interfacing wedge 412 and bridge chassis 200. The height of the saddle element 410′ remains the same as the height adjustment fixing 414 prevents the saddle element 410′ sliding down the inclined surface 800. However, the saddle element 410′ is urged against the inclined surface 800 and secured in position by the tension of the height adjustment fixing 414 and the intonation locking fixing 404, which act in different directions.

Referring to FIGS. 12a to 12e, it is now explained how the height of the height adjustable saddle 202 above the bridge chassis 200 is reduced. In order to achieve this, the length of the height adjustment fixing 414 is increased. In the illustrated embodiment, this is achieved by rotating the height adjustment fixing 414 counter-clockwise relative to the hole 904 of the saddle element 410′ in which the height adjustment fixing 414 is secured, as illustrated by arrows N in FIG. 12b. This increasing of the length of the height adjustment fixing 414 has the effect of allowing the saddle element 410′ to slide down the inclined surface 800 of the interfacing wedge 412, as described above. This is encouraged in use by the tension of the string 106 on the saddle element 410′, bearing in mind the break angle B. The change in height is illustrated by the different positions of the saddle element 410′ in FIGS. 12b and 12c.

Referring to FIG. 12d, the next step is to reduce the length of the intonation locking fixing 404, e.g. rotate the threaded bolt 404a is clockwise relative to the captive nut 404b, as illustrated by arrows M in FIG. 12d. This reduction in the length of the intonation locking fixing 404, or more specifically the distance between the head of the threaded bolt 404a of the intonation locking fixing 404 and captive nut 404b, urges the saddle element 410′ against the inclined surface 800 of the interfacing wedge 412, as before, as illustrated in FIG. 12e. This again secures the saddle element 410′ in position by the tension of the height adjustment fixing 414 and the tension of the intonation locking fixing 404, which act in different directions.

Referring to FIGS. 13a to 13d, it is also explained how the position of the height adjustable saddles 202 can be adjusted in the intonation slots 402 to adjust the precise length of the strings 106 supported by the height adjustable saddles 202, from the nut 112 to the saddles 202. In order to achieve this, the length of the intonation locking fixing is first increased, e.g. the threaded bolt 404a is rotated counter-clockwise relative to the captive nut 404b, as illustrated by arrows M in FIG. 13b. This reduces the force with which the saddle 202 is urged against the surface 400 of the bridge chassis 200 on which it rests, or more precisely reduces friction between the surface 700 of the saddle 202 and the surface 400 of the bridge chassis 200. In this way, the saddle 200 may then be slid within the intonation slot to a new position. Once the desired position of the saddle 202 has been found, the length of the intonation locking fixing 404 is reduced again, e.g. the threaded bolt 404a is rotated clockwise relative to the captive nut 404b, as illustrated by arrows M in FIG. 13d. This secures the saddle 202 against the surface 400 of the bridge chassis 200. It will be appreciated that, whilst the lengthening of the intonation locking fixing 404 will have allowed some freedom of movement of the saddle element 410′ relative to the interfacing wedge 412 during this process, once the length of the intonation locking fixing 404 is reduced again, the saddle element 410′ will return to the same position relative to the interfacing wedge 412, e.g. on the inclined surface 800 of the interfacing wedge 412, and the height of the saddle element 410′ will remain unchanged.

Other embodiments of the invention will occur to the skilled person. Likewise, different elements of the embodiments described above may be combined in different ways to implement variations of the invention different from the embodiments illustrated in the accompanying drawings.

1-8 (canceled)

9. A bridge for a stringed instrument, the bridge comprising:
a bridge chassis; and
at least one saddle for supporting a string of the stringed instrument, wherein the saddle comprises:
a saddle element for receiving the string;
a height adjustment fixing;
an intonation locking fixing; and
an interfacing wedge arranged to abut the saddle element such that movement of the saddle element over an inclined surface of the interfacing wedge results in a change in a height of the saddle element with respect to the bridge chassis, wherein the height adjustment fixing and the intonation locking fixing are manipulable to urge the saddle element against the inclined surface of the interfacing wedge in respective different directions and thereby to lock the saddle element in a desired position against the inclined surface of the interfacing wedge.

10. The bridge of claim 9, wherein the inclined surface has an angle of incline between 30 and 60 degrees relative to a direction along a length of the string received by saddle element.

11. The bridge of claim 9, wherein the intonation locking fixing is arrangeable in a first position to urge the saddle element towards the bridge chassis.

12. The bridge of claim 11, wherein the intonation locking fixing is arrangeable in a second position to be slidable in an intonation slot in the bridge chassis to adjust a position of the saddle element in an intonation direction.

13. The bridge of claim 9, wherein the height adjustment fixing is arrangeable in a first position to set a position of the saddle element on the inclined surface of the interfacing wedge.

14. The bridge of claim 9, wherein the intonation locking fixing and height adjustment fixing extend substantially perpendicularly to one another.

15. The bridge of claim 9, wherein the saddle element has a slot for accommodating a string of the stringed instrument along a length of the slot.

16. A stringed instrument comprising the bridge of claim 9.
